(19) United States
(12) Patent Application Publication
(10) Pub. No.: US 2011/0273590 A1
(43) Pub. Date: Nov. 10, 2011

(54) IMAGING DEVICE

(75) Inventors: Kazuhiro Kojima, Osaka City (JP); Yoshiyuki Tsuda, Hirakata City (JP)

(73) Assignee: SANYO ELECTRIC CO., LTD., Moriguchi City (JP)

(21) Appl. No.: 13/102,829

(22) Filed: May 6, 2011

(30) Foreign Application Priority Data
May 6, 2010 (JP) 2010-106091

(51) Int. Cl. H04N 5/76

(52) U.S. Cl. 348/231.99; 348/E05.031

(57) ABSTRACT

An imaging device includes: an input moving image obtaining portion which obtains input moving image data which is image data of a moving image; an image processing portion which includes a plurality of processing blocks which apply predetermined processing to the input moving image data to thereby generate output moving image data; an operation portion which accepts a plurality of operations including a starting operation in which an instruction to start image recording is given; and a control portion which selects any of the plurality of processing blocks as a target processing block and, after the starting operation is performed, records the output moving image data from the target processing block into a recording medium. The control portion switches a processing block to be selected as the target processing block among the plurality of processing blocks according to an operation performed on the operation portion.

This nonprovisional application claims priority under 35 U.S.C. §119(a) on Patent Application No. 2010-106091 filed in Japan on May 6, 2010, the entire contents of which are hereby incorporated by reference.

### BACKGROUND OF THE INVENTION

1. Field of the Invention

The present invention relates to an imaging device that is capable of shooting and recording a moving image.

2. Description of Related Art

Digital video cameras are typically provided with a record button. A user of such a digital camera is allowed to give an instruction to start image recording by pressing the record button and to give an instruction to stop (that is, to finish) image recording by pressing the record button again or by pressing a separately provided stop button. The user gives instructions to start and stop the image recording such that a scene that he or she desires to securely record takes place during a recording period.

The digital video camera is provided with an encoder that performs the encoding of moving image data; recording of moving image data into a recording medium is performed after encoding processing performed on the moving image data by the encoder. The encoder is not able to execute the encoding processing again until a required warm-up period elapses after the encoder finishes execution of the encoding processing according to the instruction to stop image recording (see FIG. 4). When the required warm-up period elapses after the encoding processing is finished, the encoder is in a stand-by state in which the encoder is ready to immediately start the encoding processing again. The required warm-up period is essential due to the characteristics of hardware and software involved in the operation of the encoder, and the required wallii-up period has a predetermined length (for example, several seconds).

With reference to FIG. 11, a first practical usage example of the conventional imaging device will be described. Now, assume that a user as a photographer is going to record an image of a scene in which the bride and groom in a wedding come into the wedding place where the photographer is present (the same applies to a second practical usage example which will be described later). At time T_{A1}, the master of the wedding makes an announcement that the bride and groom are about to come into the wedding place. On hearing the announcement, the photographer gives a digital video camera an instruction to start image recording. In response to the instruction, image recording is started at time T_{A1} or slightly after time T_{A1}. Assume, however, that the bride and groom actually do not come into the wedding place soon, but comes into the wedding place at time T_{A2}, which is a considerable length of time (for example, 30 seconds) after time T_{A1}.

The photographer desires to record the scene of the bride and groom coming into the wedding place, and it is the most desirable for the photographer to start the moving image shooting all over again by setting the image-recording starting time to time T_{A2}. In other words, it is the most desirable for the photographer to change the time for starting the image recording from time T_{A1} to time T_{A2}. However, it is difficult for the photographer to predict when the bride and groom will come into the wedding place before they actually do. If the image recording is suspended at time T_{A2}′ that is immediately before time T_{A2}, the photographer may miss the scene of the bride and groom coming into the wedding place, which is the most important scene, due to the presence of the required warm-up period. Thus, if the photographer gives priority to avoiding the missing of the scene of the bride and groom coming into the wedding place, it is impossible for the photographer to suspend the image recording. As a result, as shown in FIG. 11, redundant moving image data 901, including a scene shot between time T_{A1} and time T_{A2} which may be called an unnecessary scene, is recorded.

With reference to FIG. 12, a second practical usage example of a conventional imaging device will be described. At time T_{B1}, the master of the wedding makes an announcement that the bride and groom are about to come into the wedding place. On hearing the announcement, the photographer gives the digital video camera an instruction to start image recording. In response to the instruction, image recording is started at time T_{B1} or slightly after time T_{B1}. Here, assume the following: that is, the photographer then records the scene of the bride and groom actually coming into the wedding place, and at time T_{B2}, the photographer judges that the recording of the entrance scene has been completed, and gives the digital video camera an instruction to stop the image recording, but, at time T_{B3} which is immediately after time T_{B2}, a scene takes place which is so impressive that the photographer desires to record a moving image of the scene. In such a case, the photographer hurriedly gives the digital video camera an instruction to start image recording again. However, the presence of the required warm-up period does not allow the digital video camera to start image recording again immediately at time T_{B3}, and it actually starts the image recording again at time T_{B4}, which is after time T_{B3}. Thereafter, the photographer again gives the digital video camera an instruction to stop the image recording at time T_{B5}.

As a result, as shown in FIG. 12, moving image data 911 obtained between time T_{B1} and time T_{B2} and moving image data 912 obtained between time T_{B4} and time T_{B5} are stored in a recording medium of the digital video camera, but the scene between time T_{B2} and time T_{B4}, which is one of important scenes, is not included in the moving image data stored in the recording medium. If it is possible to cancel the instruction to stop the image recording that is given at time T_{B2} and change the recording finishing time from time T_{B2} to a time point after time T_{B2}, the photographer is able to avoid missing the important scene, but the conventional digital video camera is not able to fulfill such requirement.

Incidentally, a technology has been proposed in which, when a shutter key operation is performed, first and second image shooting periods specified by the photographer are used to store a moving image corresponding to the first image shooting period which is before the shutter key operation and a moving image corresponding to the second image shooting period which is after the shutter key operation. However, this technology is for storing data of a moving image shot around a time point at which a still image is shot, and does not contribute to solving the conventional problem which is described above with reference to FIGS. 11 and 12.

### SUMMARY OF THE INVENTION

According to the present invention, an imaging device includes: an input moving image obtaining portion which obtains input moving image data which is image data of a moving image; an image processing portion which includes a plurality of processing blocks which apply predetermined processing to the input moving image data to thereby generate output moving image data; an operation portion which accepts a plurality of operations including a starting operation in which an instruction to start image recording is given; and a control portion which selects any of the plurality of processing blocks as a target processing block and, after the starting operation is performed, records the output moving image data from the target processing block into a recording medium. Here, the control portion switches a processing block to be selected as the target processing block among the plurality of processing blocks according to an operation performed on the operation portion.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is a block diagram showing the overall structure of an imaging device embodying the present invention;

FIG. 2 is diagram showing the internal structure of an imaging portion of FIG. 1;

FIGS. 3A to 3C are each a diagram showing an example of buttons that can be arranged in an operation portion of FIG. 1;

FIG. 4 is a diagram for illustrating how the state of an encoder changes;

FIG. 5 is a conceptual diagram of a first operative example embodying the present invention;

FIG. 6 is a modified conceptual diagram of the first operative example embodying the present invention;

FIG. 7 is a conceptual diagram of a second operative example embodying the present invention;

FIG. 8 is a conceptual diagram of a third operative example embodying the present invention;

FIG. 9 is a conceptual diagram of a fourth operative example embodying the present invention;

FIG. 10 is a diagram showing how two image files are combined;

FIG. 11 is a diagram showing a first practical usage example of a conventional imaging device; and

FIG. 12 is a diagram showing a second practical usage example of the conventional imaging device.

### DETAILED DESCRIPTION OF PREFERRED EMBODIMENTS

Hereinafter, an embodiment of the present invention will be described specifically with respect to the drawings. Among different drawings referred to in the course of the description, the same parts are identified by the same reference signs (numerals), and in principle no overlapping description of the same parts will be repeated.

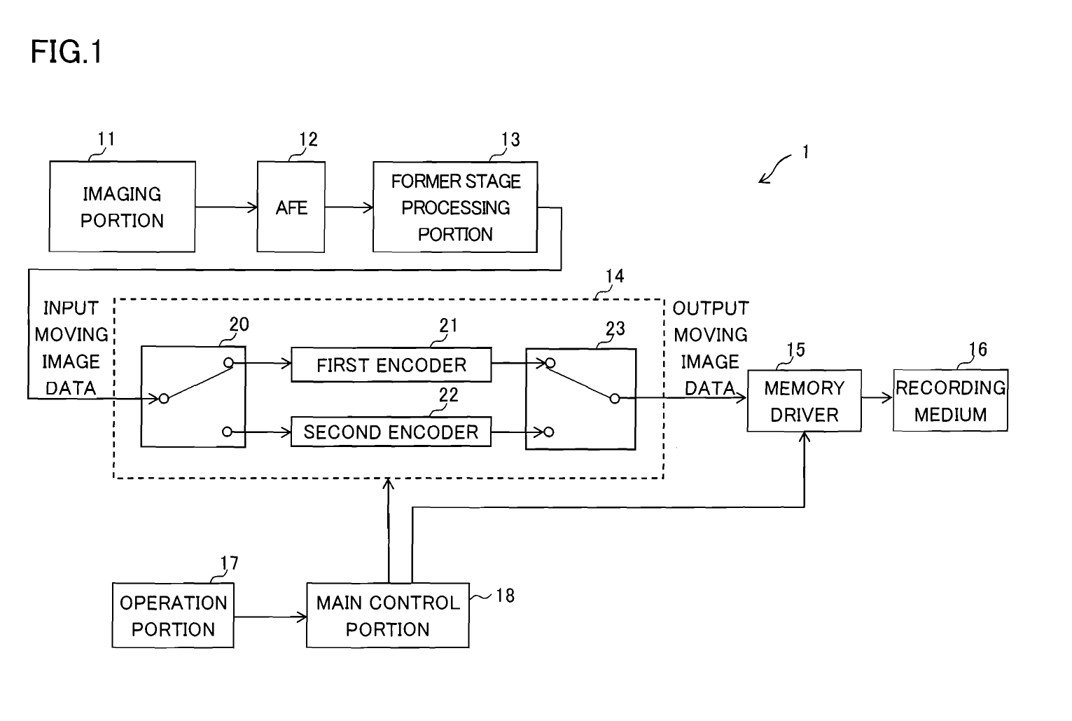

FIG. 1 is a block diagram showing the overall structure of an imaging device embodying the present invention. The imaging device 1 includes portions denoted by reference numerals 11 to 18. The imaging device 1 is a digital video camera that is capable of shooting still and moving images. Although not shown in FIG. 1, the imaging device 1 may further include portions such as a display portion formed of a liquid crystal display panel or the like, a microphone portion that converts sound picked up around the imaging device 1 to an audio signal, and a speaker portion that reproduces sound from the audio signal and outputs the resulting sound.

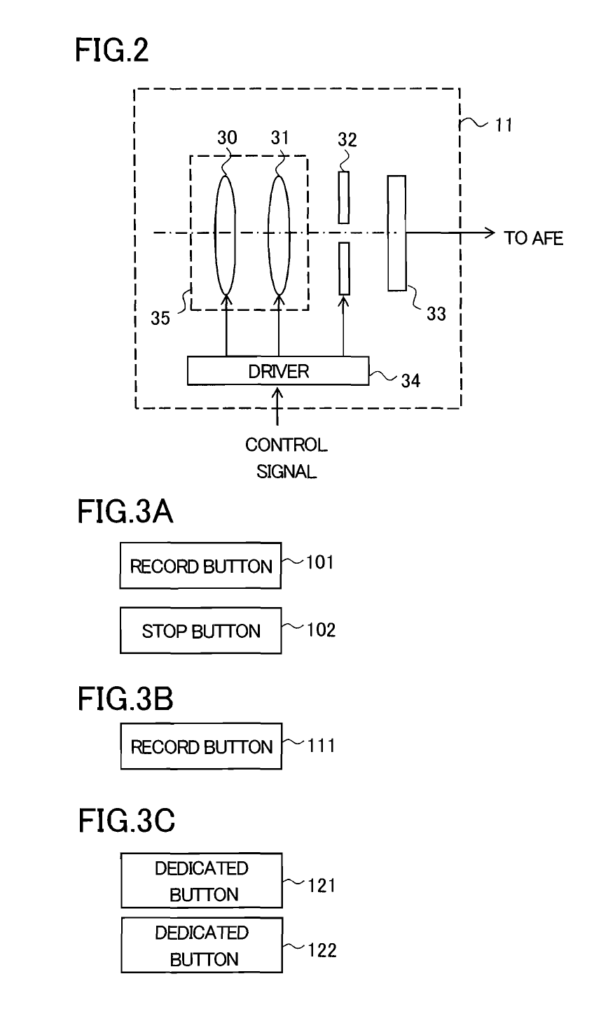

FIG. 2 is a diagram showing the internal structure of an imaging portion 11. The imaging portion 11 includes: an optical system 35; an aperture stop 32; an image sensor 33 such as a CCD (charge coupled device) or CMOS (complementary metal oxide semiconductor) image sensor; and a driver 34 which drives and controls the optical system 35 and the aperture stop 32. The optical system 35 is formed of a plurality of lenses including a zoom lens 30 and a focus lens 31. The zoom lens 30 and the focus lens 31 are movable along an optical axis. The driver 34 drives the zoom and focus lenses 30 and 31 and the aperture stop 32 to control the positions of the former and the aperture size of the latter based on a control signal from a main control portion 18, to thereby control the focal length (the angle of view) and the focus position of the imaging portion 11 and the amount of light incident on the image sensor 33 (in other words, the aperture value).

An AFE 12 amplifies an analog signal outputted from the image sensor 33, converts the amplified analog signal into a digital signal, and outputs the obtained digital signal to a former stage processing portion 13.

The former stage processing portion 13 applies predetermined former stage processing (demosaicing processing, noise reduction processing, etc) to the signal outputted from the AFE 12, and outputs the resulting signal to an image processing portion 14. As described above, the imaging device 1 is also capable of shooting and recording a still image, but the following description of the present embodiment will be focused on characteristic operations and structures related to the shooting and recording of a moving image. Image data of a moving image fed from the former stage processing portion 13 to the image processing portion 14 will be referred to as input moving image data. The input moving image data is image data of a moving image based on a signal outputted from the image sensor 33. The image sensor 33 sequentially performs image shooting at a predetermined frame rate (for example, 60 fps (frame per second)) to thereby generate a signal based on which the input moving image data is generated.

The image processing portion 14 includes an input switching portion 20, an output switching portion 23, an encoder 21 which is a first encoder, and an encoder 22 which is a second encoder; the image processing portion 14 selectively uses the encoders 21 and 22 to generate output moving image data from the input moving image data. A state of the image processing portion 14 for which the encoder 21 is selected will be referred to as a first selection state, and a state of the image processing portion 14 for which the encoder 22 is selected will be referred to as a second selection state.

In the first selection state, the input moving image data is fed via the input switching portion 20 to the encoder 21, and the encoder 21 executes predetermined encoding processing on the input moving image data to thereby generate output moving image data to be fed via the output switching portion 23 to a memory driver 15. In the second selection state, the input moving image data is fed via the input switching portion 20 to the encoder 22, and the encoder 22 executes predetermined encoding processing on the input moving image data to thereby generate output moving image data to be fed via the output switching portion 23 to the memory driver 15.

Steps of the encoding processing performed by the encoder 21 in the first selection state are the same as steps of the encoding processing performed by the encoder 22 in the second selection state. The input moving image data is encoded through the encoding processing, and the resulting encoded moving image data is generated as the output moving image data. Any method may be adopted as the encoding method in the encoding processing, and the method may comply with any specification. For example, it is possible to make the encoding method in the encoding processing comply with H.264 or MPEG-4 (Moving Picture Experts Group-4).

The memory driver 15 creates an image file in a recording medium 16, and stores the output moving image data into the image file. Thereby, the output moving image data is recorded in the recording medium 16. The memory driver 15 operates under control of the main control portion 18, and thus, in the following description, an event in which the memory driver 15 records the output moving image data into the recording medium 16 may be described, for example, as an event in which the main control portion 18 records the output moving image data into the recording medium 16. Incidentally, the recording, the storing and the accommodating of data here are used synonymously with one another. The recording medium 16 is a nonvolatile memory such as a semiconductor memory, a magnetic disc, or the like.

An operation portion 17 accepts various operations performed by a user. Information as to which operation has been performed on the operation portion 17 is transmitted to the main control portion 18. The main control portion 18 controls various portions of the imaging device 1 in a centralized manner. In particular, according to which operation has been performed on the operation portion 17, the main control portion 18 switches the state of the imaging processing portion 14 between the first and second selection states.

An encoder that generates output moving image data that should be fed to the memory driver 15 will be particularly called an effective encoder, and encoders other than the effective encoder will each be called an ineffective encoder. In the first selection state, the encoder 21 is the effective encoder and the encoder 22 is the ineffective encoder. In the second selection state, the encoder 21 is the ineffective encoder and the encoder 22 is the effective encoder. The processing of switching the state of the image processing portion 14 between the first and second selection states can be said to be processing of selecting an effective encoder from the encoders 21 and 22, or processing of switching an encoder (a processing block) to be selected as the effective encoder (a target processing block) between the encoders 21 and 22.

In the first selection state, it is possible to feed the input moving image data not only to the encoder 21 but also to the encoder 22 and make both the encoders 21 and 22 execute the encoding processing, but it is advisable that the operation (including the operation of executing the encoding processing) by the encoder 22 be stopped in the first selection state. Likewise, in the second selection state, it is possible to feed the input moving image data not only to the encoder 22 but also to the encoder 21 and make both the encoders 21 and 22 execute the encoding processing, but it is advisable that the operation (including the operation of executing the encoding processing) by the encoder 21 be stopped in the second selection state. By stopping the operations as described above, wasteful power consumption and the like can be reduced.

Operations that the user is allowed to perform on the operation portion 17 include: a first instruction operation for giving an instruction to start image recording; a second instruction operation for giving an instruction to stop image recording; a third instruction operation for giving an instruction to cancel an already performed operation; and a fourth instruction operation for giving an instruction to restart image recording. However, it is possible to omit one of the third and fourth instruction operations. The term “image recording” or the term “recording” means recording image data of a moving image obtained by using the image sensor 33 into the recording medium 16.

When the first instruction operation is performed on the operation portion 17, a recording start signal is generated in the operation portion 17 to be transmitted to the main control portion 18 and the image processing portion 14;

when the second instruction operation is performed on the operation portion 17, a recording stop signal is generated in the operation portion 17 to be transmitted to the main control portion 18 and the image processing portion 14;

when the third instruction operation is performed on the operation portion 17, a cancellation signal is generated in the operation portion 17 to be transmitted to the main control portion 18 and the image processing portion 14; and

when the fourth instruction operation is performed on the operation portion 17, a recording restart signal is generated in the operation portion 17 to be transmitted to the main control portion 18 and the image processing portion 14.

The first to fourth instruction operations are different from one another. A separate button may be assigned to each instruction operation, or it is also possible to assign a plurality of instruction operations to a common button such that the plurality of instruction operations are each realized as an operation on the common button. There will be described some examples below, which are adoptable in the imaging device 1, of the method of assigning the first to fourth instruction operations to buttons.

In a first method of assignment of the first and second instruction operations, a record button 101 and a stop button 102, which are shown in FIG. 3A and different from each other, are provided in the operation portion 17, and the first and second instruction operations are assigned to the record button 101 and the stop button 102, respectively. In this case, an operation of pressing the record button 101 and an operation of pressing the stop button 102 are the first and second instruction operations, respectively.

In a second method of assignment of the first and second instruction operations, a record button 111 shown in FIG. 3B is provided in the operation portion 17, and the first and second instruction operations are assigned to the record button 111. In this case, it is possible to operate the record button 111 such that an odd-numbered operation of pressing the record button 111 corresponds to the first instruction operation and an even-numbered operation of pressing the record button 111 corresponds to the second instruction operation.

In a first method of assignment of the third and fourth instruction operations, dedicated buttons 121 and 122, which are shown in FIG. 3C and different from each other, are provided in the operation portion 17, and the third and fourth instruction operations are assigned to the dedicated buttons 121 and 122, respectively. In this case, an operation of pressing the dedicated button 121 and an operation of pressing the dedicated button 122 are the third and fourth instruction operations, respectively.

A second method of assignment of the third and fourth instruction operations is realized in combination with the above-described first method of assignment of the first and second instruction operations. In this method, operations of pressing the record button 101 and the stop button 102 for less than a predetermined length of time correspond to the first and second instruction operations, respectively. On the other hand, operations of pressing the record button 101 and the stop button 102 for the predetermined length of time or longer correspond to the third and fourth instruction operations, respectively. Alternatively, operations of pressing the record button 101 and the stop button 102 for the predetermined length of time or longer correspond to the fourth and third instruction operations, respectively.

A third method of assignment of the third and fourth instruction operations is also realized in combination with the above-described first method of assignment of the first and second instruction operations. In this method, an odd-numbered operation of pressing the record button 101 corresponds to the first instruction operation and an even-numbered operation of pressing the record button 101 corresponds to the third or fourth instruction operation. Alternatively, an odd-numbered operation of pressing the stop button 102 corresponds to the second instruction operation and an even-numbered operation of pressing the stop button 102 corresponds to the third or fourth instruction operation.

Various other methods of button assignment are adoptable, and examples of such methods of button assignment will be described along with descriptions of practical operation examples which will be described later. Incidentally, in a case where a display portion (not shown) provided in the imaging device 1 is equipped with a touch panel function, the above-described buttons may be realized as buttons displayed on the display portion. In this case, the display portion functions as an operation portion as well. The above description deals with examples where each of the instruction operations corresponds to a pressing operation of a button; however, each of the instruction operations may be an operation other than pressing a button. For example, each of the instruction operations may be an operation of turning a dial or any operation on a touch panel (for example, tracing the display screen surface with a finger).

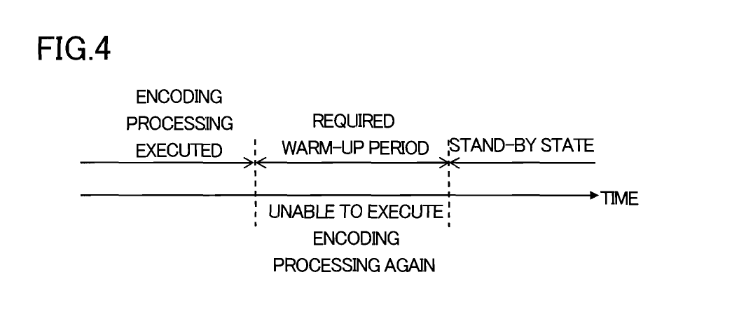

As shown in FIG. 4, unless a required warm-up period having a predetermined length (for example, several seconds) elapses after the encoder 21 finishes executing the encoding processing according to the instruction to stop image recording, the encoder 21 is not able to execute the encoding processing again. This applies to the encoder 22 as well. When the required warm-up period elapses after the encoder 21 finishes executing the encoding processing, the state of the encoder 21 shifts to a stand-by state (this applies to the encoder 22 as well). When the encoder 21 is in the stand-by state, if the input moving image data is fed to the encoder 21, the encoder 21 is able to immediately execute the encoding processing (this applies to the encoder 22 as well).

The state of each encoder may be presented to the user by using the display portion (not shown) or the like provided in the imaging device 1. For example, the above-mentioned display portion may display, with respect to each of the encoders, whether the encoder is in the state of performing the encoding processing, in the state of waiting for the required warm-up period to elapse, or in the stand-by state. Furthermore, for example, the above-mentioned display portion may display which encoder is currently performing the encoding processing, and which encoder is not currently performing the encoding processing. Furthermore, for example, the above-mentioned display portion may display the detail of the processing that each encoder is currently performing. Furthermore, for example, when the encoder 21 is in the state of waiting for the required warm-up period to elapse, the above-mentioned display portion may display how much time needs to elapse before the state of the encoder 21 shifts to the stand-by state (this applies to the encoder 22 as well). These displays make it possible for the user to know the correct system state of the imaging device 1, and thus to make efficient use of the system.

Next, first to fourth operative examples will be described as operative examples of the operation of the imaging device 1.

### First Operative Example

The first operative example will be described. FIG. 5 is a conceptual diagram of the first operative example. It is assumed that time t_{A1}, t_{A2} and t_{A3} come in this order as time proceeds. That is, time t_{Ai+1} comes after time t_{Ai} (i is an integer). Assume that a sufficient length of time elapses until time t_{A1} after the imaging device 1 is started up, that no instruction is given to start image recording before time t_{A1}, and that the state of the image processing portion 14 immediately before time t_{A1} is the first selection state. It is also assumed that image files F₁ and F₂ are different image files.

In the first operative example, it is assumed that the recording start signal is generated by the user performing the first instruction operation at time t_{A1}, that the recording restart signal is generated by the user performing the fourth instruction operation at time t_{A2}, and that the recording stop signal is generated by the user performing the second instruction operation at time t_{A3}. The input moving image data obtained through shooting performed between time t_{A1} and time t_{A3} is fed to the image processing portion 14 between time t_{A1} and time t_{A3}.

Since the image processing portion 14 is in the first selection state at time t_{A1}, the encoder 21 executes the encoding processing on the input moving image data obtained through shooting performed between time t_{A1} and time t_{A2}, to thereby generate the output moving image data between time t_{A1} and time t_{A2} based on the input moving image data between time t_{A1} and time t_{A2}. Between time t_{A1} and time t_{A2}, the memory driver 15 creates the image file F₁ in the recording medium 16, and accommodates the output moving image data between time t_{A1} and time t_{A2} into the image file F₁ under the control of the main control portion 18.

When the recording restart signal is generated at time t_{A2}, the main control portion 18, at time t_{A2} or immediately after time t_{A2}, quickly switches the state of the image processing portion 14 from the first selection state to the second selection state (that is, switches the encoder to be selected as the effective encoder from the encoder 21 to the encoder 22).

Since the encoder 22 is in the stand-by state at time t_{A2} (see FIG. 4), the encoder 22 is able to start executing the encoding processing immediately at time t_{A2}. The encoder 22 executes the encoding processing on the input moving image data obtained through shooting performed between time t_{A2} and time t_{A3}, to thereby generate the output moving image data between time t_{A2} and time t_{A3} based on the input moving image data between time t_{A2} and time t_{A3}. Between time t_{A2} and time t_{A3}, the memory driver 15 creates the image file F₂ in the recording medium 16, and accommodates the output moving image data between time t_{A2} and time t_{A3} into the image file F₂ under the control of the main control portion 18.

When the recording stop signal is generated at time t_{A3}, the main control portion 18 stops the encoding processing executed by the encoder 22. Unless a particular operation is performed after time t_{A3}, the image file F₁ in which the output moving image data between time t_{A1} and time t_{A2} is accommodated and the image file F₂ in which the output moving image data between time t_{A2} and time t_{A3} is accommodated remain stored in the recording medium 16. In a case where the image files are given file numbers as sequential numbers according to the order of generation, the main control portion 18, for example, gives a file number “001” to the image file F₁ and a file number “002” to the image file F₂.

Incidentally, if a recording restart signal is generated instead of the recording stop signal at time t_{A3}, which is different from the situation illustrated in FIG. 5, the state of the image processing portion 14 is switched from the second selection state to the first selection state at time t_{A3} or immediately after time t_{A3}, which allows the encoder 21 to start executing the encoding processing immediately at time t_{A3} (note that it is assumed that the time length between time t_{A2} and time t_{A3} is longer than the length of the required warm-up period).

As described above, by providing a plurality of encoders such that the effective encoder is switched among them in response to the generation of the recoding restart signal, it is possible to start image recording all over again at a desired time even in the middle of recording. That is, recording starting time can be changed as often as desired. In the example shown in FIG. 5, the image file F₂ is the file of the image with respect to which the recording starting time is changed, and for example, the image file F₂ can be considered as the file of the moving image that the user truly desires to obtain.

In a case in which a user finds the scene shot between time t_{A1} and time t_{A2} of no importance to him or her, and thus desires to start image recording all over again at time t_{A2}, if the user is using a conventional imaging device, he or she needs to suspend the recording operation once and then give an instruction to start image recording again. With the conventional imaging device, however, if the user stops image recording once, recording cannot be restarted until the required warm-up period elapses thereafter, and this may cause the user to miss a chance of shooting an important scene happening during the required warm-up period. Or, if the user of the conventional imaging device desires to avoid failing to shoot an important scene, he or she needs to give up suspending the image recording, which often results in generation of an image file containing a redundant scene. In contrast, according to the present embodiment, a user is able to start image recording all over again at time t_{A2} by performing the operation for generating the recording restart signal at time t_{A2}. This makes it possible to restart image recording immediately at time t_{A2} even in the middle of a recording operation, and thus to obtain the image file F₂ which does not contain a redundant scene.

Incidentally, if the user finds it unnecessary to store the image file F₁, he or she is able to delete the image file F₁ from the recording medium 16 later by performing a predetermined operation on the operation portion 17.

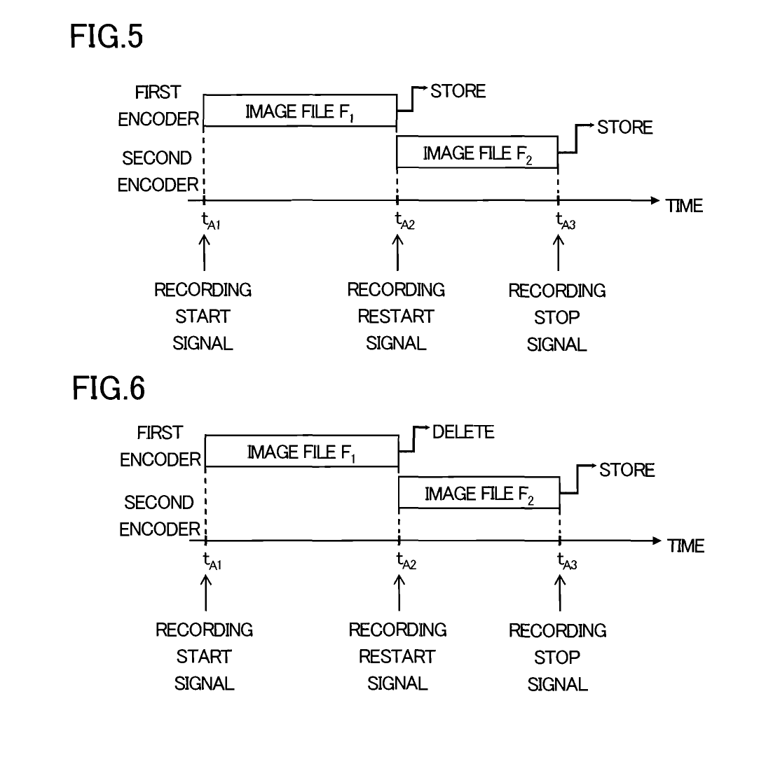

Alternatively, after the recording restart signal is generated at time t_{A2}, the image file F₁, being considered as an unnecessary file, may be deleted from the recording medium 16 independently of an operation by the user (see FIG. 6). This deletion of the image file F₁ is executed by the memory driver 15 under the control of the main control portion 18. When this deletion is performed, advisably, the file number of the image file F₂ is changed from “002”, which has been given to the image file F₂, to the file number “001” under the control of the main control portion 18. Furthermore, in the case in which the image file F₁ is deleted from the recording medium 16 with no operation by the user to automatically change the file number of the image file F₂ from “002” to “001”, presentation may be made to inform the user of the deletion and the file-number change. This presentation can be realized by using a display portion (not shown) provided in the imaging device 1. More specifically, it is advisable to present the user with information to the effect that the file number of the image file F₂ has been changed from “002” to “001” and that an image file that is stored after the image file F₂ will be given the file number “002”, etc. This enables the user to realize that a file operation (in this example, changing the file number, etc.) has been carried out, and thus to appropriately understand the correspondence between file numbers and image files.

### Second Operative Example

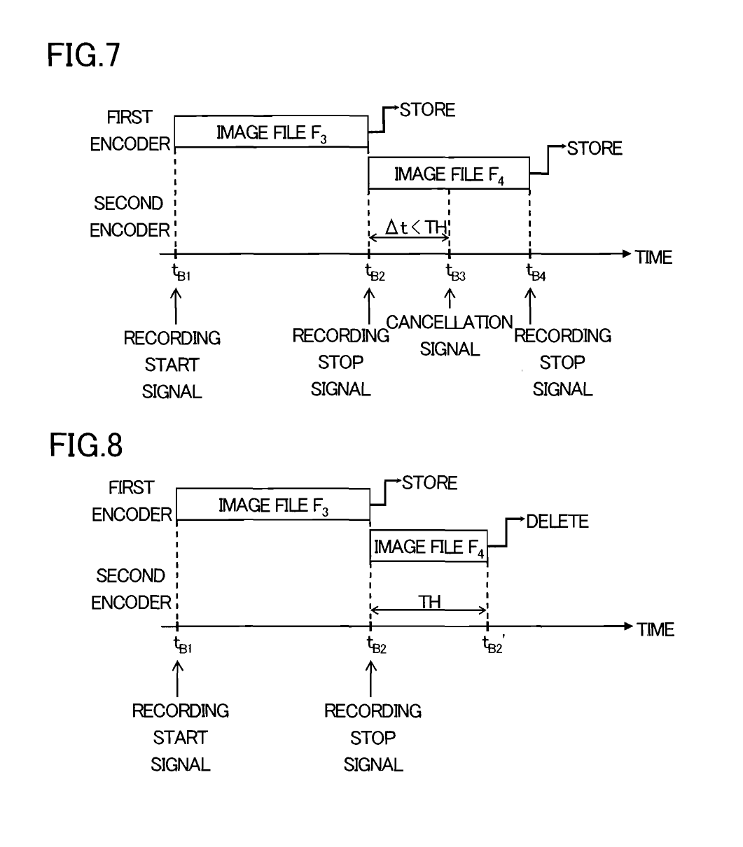

A second operative example will be described. FIG. 7 is a conceptual diagram of the second operative example. It is assumed that time t_{B1}, t_{B2}, t_{B3} and t_{B4} come in this order as time proceeds. That is, time t_{Bi+1} comes after time t_{Bi} (i is an integer). Assume that a sufficient length of time elapses until time t_{B1} after the imaging device 1 is started up, that no instruction is given to start image recording before time t_{B1}, and that the state of the image processing portion 14 immediately before time t_{B1} is the first selection state (this also applies to later-described third and fourth operative examples). In addition, assume that image files F₃ and F₄ are image files which are different from each other (this also applies to the later-described third and fourth operative examples).

In the second operative example, it is assumed that the recording start signal is generated at time t_{B1} by the user performing the first instruction operation, that the recording stop signal is generated at time t_{B2} by the user performing the second instruction operation, that the cancellation signal is generated at time t_{A3} by the user performing the third instruction operation, and that the recording stop signal is generated again by the user performing the second instruction operation again at time t_{B4}. The length of time Δt between time t_{B2} and time t_{B3} is shorter than a predetermined reference time TH. The input moving image data obtained through shooting performed between time t_{B1} and time t_{B4} is fed to the image processing portion 14 between time t_{B1} and time t_{B4}.

Since the image processing portion 14 is in the first selection state at time t_{B1}, the encoder 21 executes the encoding processing on the input moving image data obtained through shooting performed between time t_{B1} and time t_{B2}, to thereby generate the output moving image data between time t_{B1} and time t_{B2} based on the input moving image data between time t_{B1} and time t_{B2}. Between time t_{B1} and time t_{B2}, the memory driver 15 creates the image file F₃ in the recording medium 16, and accommodates the output moving image data between time t_{B1} and time t_{B2} in the image file F₃ under the control of the main control portion 18.

And, when the recording stop signal is generated at time t_{B2}, the main control portion 18, at time t_{B2} or immediately after time t_{B2}, quickly switches the state of the image processing portion 14 from the first selection state to the second selection state (that is, switches the encoder to be selected as the effective encoder from the encoder 21 to the encoder 22). Since the encoder 22 is in the stand-by state at time t_{B2} (see FIG. 4), the encoder 22 is able to start executing the encoding processing immediately at time t_{B2}.

Here, a file operation performed in the second operative example will be described, with time at which a recording stop signal is generated indicated by t_{B}. Incidentally, FIG. 8 is a conceptual diagram of a later-described third operative example, which will be referred to, for convenience sake, in the following description of the detail of the file operation. When the recording stop signal is generated, the main control portion 18 starts counting time elapsing from time t_{B} at which the recording stop signal is generated, and monitors whether or not the cancellation signal is generated by time (t_{B}+TH). Time (t_{B}+TH) indicates time that comes when the reference time TH elapses after time t_{B}. And, after time t_{B}, if the cancellation signal is found to be generated by time (t_{B}+TH), the main control portion 18 makes a cancellation judgment, and if not, an effectiveness judgment. Whether or not the cancellation signal is generated by time (t_{B}+TH) is not able to be determined before time (t_{B}+TH) or until the cancellation signal is found to have been generated. Thus, until the determination is made, the main control portion 18 makes the effective encoder perform the encoding processing, accommodates the obtained output moving image data into an image file, and keeps the image file recorded in the recording medium 16.

In the case in which the cancellation judgment is made, the main control portion 18 considers the operation performed by the user at time t_{B} (that is, the second instruction operation for generating a recording stop signal) to have been cancelled by the user; the main control portion 18 accommodates the output moving image data between time t_{B} and time t_{B}′ based on the input moving image data between time t_{B} and time t_{B}′ into an image file, and stores the image file in the recording medium 16. Here, it is assumed that a first recording stop signal is generated at time t_{B}, and a second recording stop signal is generated at time t_{B}′. Time t_{B} and time t_{B}′ in the case in which the cancellation judgment is made correspond to time t_{B2} and time t_{B4}, respectively, in the example shown in FIG. 7.

On the other hand, in the case in which the effectiveness judgment is made, the main control portion 18 determines that the operation performed by the user at time t_{B} (that is, the second instruction operation for generating the recording stop signal) to be effective; the main control portion 18 deletes, from the recording medium 16, the image file accommodating the output moving image data between time t_{B} and time (t_{B}+TH) that has been temporarily stored in the recording medium 16 between time t_{B} and time (t_{B}+TH). Time t_{B} and time (t_{B}+TH) in the case in which the effectiveness judgment is made correspond to time t_{B2} and time t_{B2}′, respectively, in the example shown in FIG. 8.

With reference to the example shown in FIG. 7, a description will be give of specific operations. In the example of FIG. 7, the cancellation signal is generated before the reference time TH elapses after time t_{B2}. Thus, the main control portion 18 makes a cancellation judgment with respect to the operation performed at time t_{B2} (that is, the second instruction operation for generating the recording stop signal), and, until a recording stop signal is generated next time, makes the encoder 22 keep functioning as the effective encoder to execute the encoding processing. Thus, the encoder 22 executes the encoding processing on the input moving image data obtained through shooting performed between time t_{B2} and time t_{B4}, to thereby generate the output moving image data between time t_{B2} and time t_{B4} based on the input moving image data between time t_{B2} and time t_{B4}. Between time t_{B2} and time t_{B4}, the memory driver 15 creates the image file F₄ in the recording medium 16, and accommodates the output moving image data between time t_{B2} and time t_{B4} into the image file F₄ under the control of the main control portion 18.

When the recording stop signal is generated at time t_{B4}, the main control portion 18 stops the encoding processing executed by the encoder 22. Unless a particular operation is performed after time t_{B4}, the image file F₃ in which the output moving image data between time t_{B1} and time t_{B2} is accommodated and the image file F₄ in which the output moving image data between time t_{B2} and time t_{B4} is accommodated remain stored in the recording medium 16. In a case where image files are given file numbers as sequential numbers in the order of generation, the main control portion 18, for example, gives a file number “001” to the image file F₃ and a file number “002” to the image file F₄.

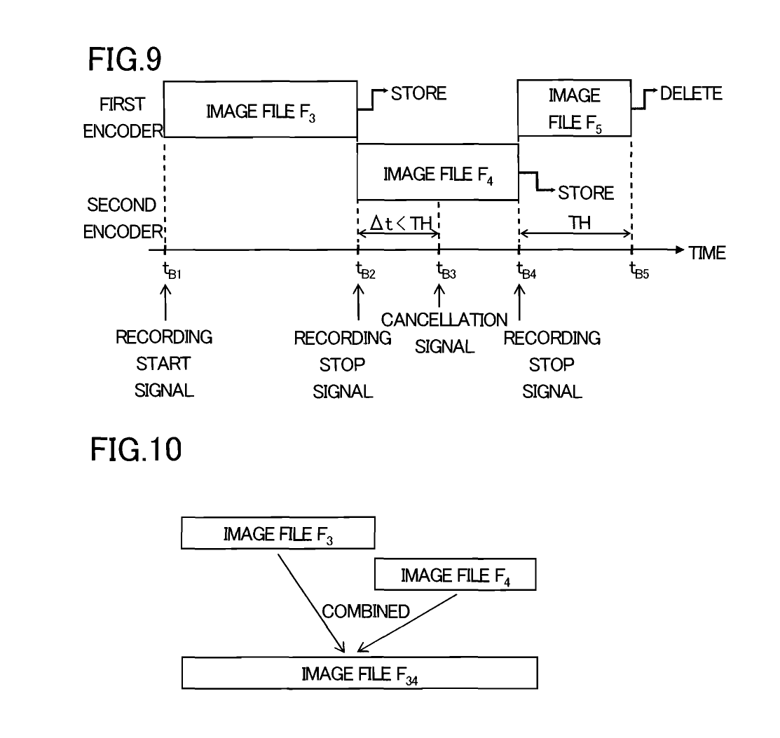

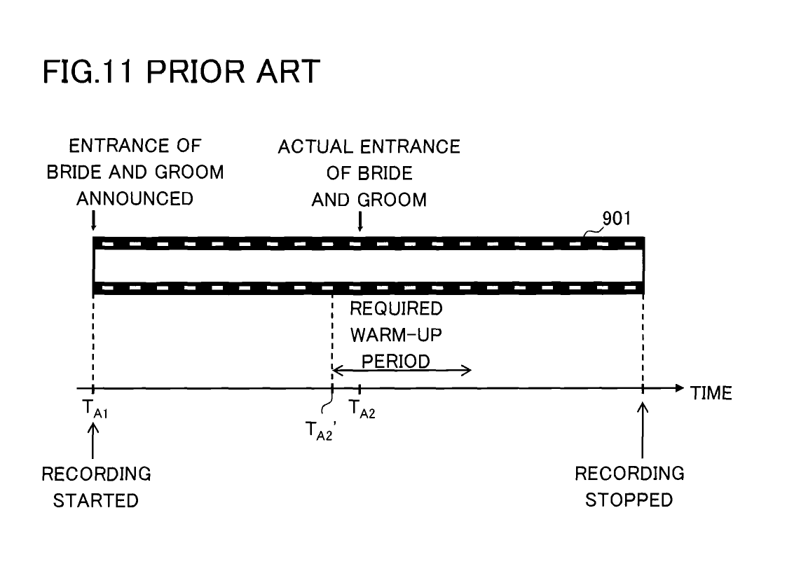

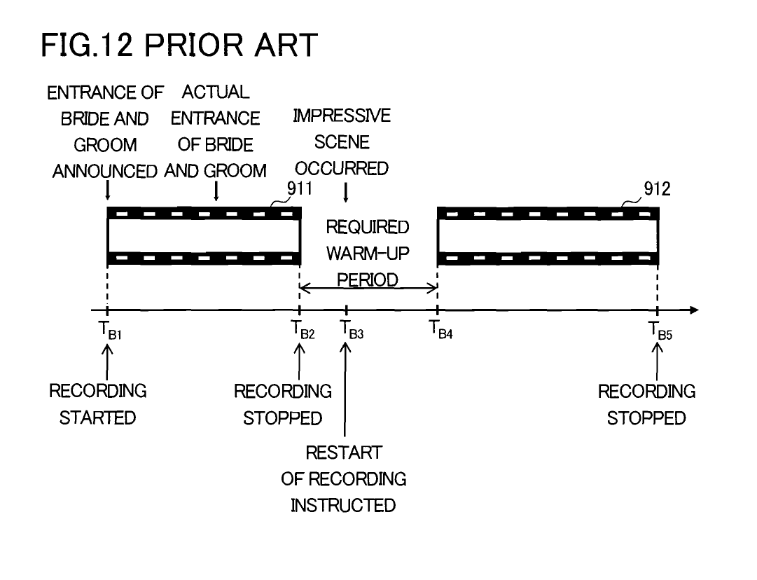

Incidentally, although no operation is indicated with respect to the time zone after time t_{B4} in FIG. 7, operations that are set to be performed after the generation of the recording stop signal including the effective encoder switching operation are performed after time t_{B4} as well (see a later-described fourth operative example which corresponds to FIG. 9).

As described above, by providing a plurality of encoders such that the effective encoder is switched among them in response to the generation of the recoding stop signal for the encoding processing to be continuously performed, even after the instruction to stop image recording is given, performance of the operation for generating the cancellation signal has the same effect as cancelling the instruction to stop image recording. In the example shown in FIG. 7, by performing the operation for generating the cancellation signal after, and in spite of, the instruction to stop image recording given at time t_{B2}, it is possible to record the moving image data between time t_{B1} and time t_{B4} into the recording medium 16 without missing any part. Thus, this method makes it possible to obtain the same effect as can be obtained by being able to change the image recording finishing time many times.

There may be a case in which an instruction to stop image recording is given at time t_{B2} but an important scene that needs to be recorded takes place thereafter. In such a case, the user of the conventional imaging device once again gives the instruction to start image recording, but with the conventional imaging device, the user is not allowed to restart image recording until after a lapse of the required warm-up period. In contrast, with the imaging device 1 according to the present embodiment, the user is allowed to restart image recording as soon as he or she performs the operation for generating the cancellation signal when he or she recognizes the important scene after time t_{B2}. Thereby, a moving image starting at time t_{B2} is recorded, and thus missing of the important scene is avoided.

After the recording stop signal is generated, information of cancellation-signal accepting time may be indicated to the user by using, for example, the display portion (not shown) of the imaging device 1 (this applies to later-described third and fourth operative examples as well). The cancellation-signal accepting time indicates time (time length) left until the end of a period during which the cancellation judgment is allowed to be made. Thus, in the examples shown in FIGS. 7 and 8, advisably, it is displayed on the display portion that the cancellation-signal accepting time is equal to a reference time TH at time t_{B2}, it is displayed on the display portion that the cancellation-signal accepting time is equal to a reference time (TH-Δt′) at time (t_{B2}+Δt′) (where 0<Δt′<TH), and, if time reaches time (t_{B2}+TH)=t_{B2}′ without generation of the cancellation signal, it is displayed on the display portion that the accepting of the cancellation-signal is finished. This applies to the fourth operative example which will be described later. Such display of the cancellation-signal accepting time makes it possible for the user to appropriately know the system state of the imaging device 1, and thus to appropriately operate the imaging device 1

### Third Operative Example

A third operative example will be described. As described above, FIG. 8 is a conceptual diagram of the third operative example. In the third operative example, like in the second operative example, the recording start signal is generated at time t_{B1} by the user performing the first instruction operation, and the recording stop signal is generated at time t_{B2} by the user performing the second instruction operation. Thus, in the third operative example, the operation performed between time t_{B1} and time t_{B2} and the operation of switching the effective encoder performed at time t_{B2} are the same as those of the second operative example described above. However, in the third operative example, it is assumed that the cancellation signal is not generated between time t_{B2} and time t_{B2}′ which comes after the reference time TH elapses from time t_{B2}.

Thus, after time t_{B2}, the following operations are performed. Before time t_{B2}′, the main control portion 18 is not able to determine whether to make a cancellation judgment or an effectiveness judgment with respect to the operation performed at time t_{B2} (that is, the second instruction operation for generating the recording stop signal). Hence, the main control portion 18 makes the effective encoder execute the encoding processing between time t_{B2} and time t_{B2}′. Thus, the encoder 22, which is the effective encoder between time t_{B2} and time t_{B2}′, executes the encoding processing on the input moving image data obtained through shooting performed between time t_{B2} and time t_{B2}′, to thereby generate the output moving image data between time t_{B2} and time t_{B2}′ based on the input moving image data between time t_{B2} and time t_{B2}′. Between time t_{B2} and time t t_{B2}′, the memory driver 15 creates the image file F₄ in the recording medium 16, and accommodates the output moving image data between time t_{B2} and time t_{B2}′ into the image file F₄ under the control of the main control portion 18.

If it is recognized that the cancellation signal is not generated between time t_{B2} and time t_{B2}′, the main control portion 18 makes the effectiveness judgment with respect to the operation performed at time t_{B2} (that is, the second instruction operation for generating the recording stop signal), and deletes, from the recording medium 16, the image file F₄ accommodating the output moving image data between time t_{B2} and time t_{B2}′ and temporarily stored in the recording medium 16 between time t_{B2} and time t_{B2}′. In this way, image data that the user does not intend to record is automatically deleted from the recording medium 16.

Incidentally, in the second or third operative example, it is possible to realize the following operations with a single record button 111 (see FIG. 3B): the first instruction operation for generating the recording start signal, the second instruction operation for generating recording stop signal, and the third instruction signal for generating the cancellation signal. In this case, an operation of pressing the record button 111 for a first time is treated as the first instruction operation and an operation of pressing the record button 111 for a second time is treated as the second instruction operation. Advisably, in a case in which, within the reference time TH after the time when an operation of pressing the record button 111 for the second time is performed, an operation of pressing the record button 111 again is performed, the operation (that is, an operation of pressing the record button 111 for a third time) is treated as the third instruction operation, and an operation of pressing the record button 111 for a fourth time is treated as the second instruction operation (see FIG. 7 as well).

On the other hand, in a case in which time that is longer than the reference time TH elapses between the operation of pressing the record button 111 for the second time and the operation of pressing the record button 111 for the third time, it is advisable that the effectiveness judgment be made with respect to the operation of pressing the record button 111 for the second time (see FIG. 8 as well), and thereafter, the operation of pressing the record button 111 for the third time be treated as the first instruction operation.

### Fourth Operative Example

A fourth operative example will be described. FIG. 9 is a conceptual diagram of the fourth operative example. Operations performed in the fourth operative example are similar to a combination of the operations performed in the above-described second and third operative examples. Signals generated at time t_{B1}, t_{B2}, t_{B3} and t_{B4}, and operations performed between time t_{B1} and time t_{B4} are the same as those generated and performed in the second operative example. Thus, unless a particular operation is performed after time t_{B4}, the image file F₃ in which the output moving image data between time t_{B1} and time t_{B2} is accommodated and the image file F₄ in which the output moving image data between time t_{B2} and time t_{B4} is accommodated remain stored in the recording medium 16.

When the recording stop signal is generated at time t_{B4}, the main control portion 18, at time t_{B4} or immediately after time t_{B4}, quickly switches the state of the image processing portion 14 from the second selection state to the first selection state (that is, switches the encoder to be selected as the effective encoder from the encoder 22 to the encoder 21). Since the encoder 21 is in the stand-by state at time t_{B4}, the encoder 21 is able to start executing the encoding processing immediately at time t_{B4}. It is desirable that the reference time TH be set to have a length equal to the required warm-up period or longer for the purpose of securely maintaining the encoder 21 in the stand-by state at time t_{B4}.

It is assumed that the cancellation signal is not generated thereafter between time t_{B4} and time t_{B5}. Time t_{B5} indicates time that comes a lapse of the reference time TH after time t_{B4}. The main control portion 18 is not able to determine, before time t_{B5}, whether to make a cancellation judgment or an effectiveness judgment with respect to the operation performed at time t_{B4} (that is, the second instruction operation for generating the recording stop signal). Hence, the main control portion 18 makes the effective encoder execute the encoding processing between time t_{B4} and time t_{B5}. Thus, the encoder 21, which is the effective encoder between time t_{B4} and time t_{B5}, executes the encoding processing on the input moving image data obtained through shooting performed between time t_{B4} and time t_{B5}, to thereby generate the output moving image data between time t_{B4} and time t_{B5} based on the input moving image data between time t_{B4} and time t_{B5}. Between time t_{B4} and time t_{B5}, the memory driver 15 creates an image file F₅ in the recording medium 16, and accommodates the output moving image data between time t_{B4} and time t_{B5} into the image file F₅ under the control of the main control portion 18.

If it is recognized that the cancellation signal is not generated between time t_{B4} and time t_{B5}, the main control portion 18 makes the effectiveness judgment with respect to the operation performed at time t_{B4} (that is, the second instruction operation for generating the recording stop signal), and deletes, from the recording medium 16, the image file F₅ accommodating the output moving image data between time t_{B4} and time t_{B5} and temporarily stored in the recording medium 16 between time t_{B4} and time t_{B5}. In this way, it is possible to automatically delete image data that the user does not intend to record from the recording medium 16.

Incidentally, considering that the operation performed by the user at time t_{B3} indicates that the user desires to cancel the instruction to stop image recording, after the image file F₃ accommodating the output moving image data between time t_{B1} and time t_{B2} and the image file F₄ accommodating the output moving image data between time t_{B2} and time t_{B4} are created, these image files may be combined to create a new image file F₃₄, and the image file F₃₄ may be stored in the recording medium 16 as shown in FIG. 10. In the case in which the image file F₃₄ is stored in the recording medium 16, it is advisable to delete the image files F₃ and F₄ from the recording medium 16. The creating and storing of the image file F₃₄ and the deleting of the image files F₃ and F₄ are executed by the memory driver 15 under the control of the main control portion 18. By combining, on the time series, the output moving image data between the time t_{B1} and time t_{B2} accommodated in the image file F₃ and the output moving image data between the time t_{B2} and time t_{B4} accommodated in the image file F₄, contiguous output moving image data between time t_{B1} and time t_{B4} is generated and the contiguous output moving image data between time t_{B1} and time t_{B4} is accommodated into the image file F₃₄.

<<Modifications and Variations>>

The specific values given in the descriptions above are merely examples, which, needless to say, may be modified to any other values. In connection with the embodiments described above, supplementary explanations applicable to them will be given below in Notes 1 to 4. Unless inconsistent, any part of the contents of these notes may be combined with any other.

[Note 1]

The imaging device 1 of FIG. 1 has the AFE 12 and the former stage processing portion 13 provided outside the encoder; all or part of the functions of the AFE 12 and the former stage processing portion 13 may be assumed by each of the encoders 21 and 22.

[Note 2]

The image processing portion 14 of FIG. 1 is provided with two encoders, but three or more encoders may be provided in the image processing portion 14. That is, N encoders each having the same function as the encoder 21 may be provided in the image processing portion 14. “N” is an integer 3 or larger. And, according to which operation is performed on the operation portion 17, the main control portion 18 may switch the encoder to be selected as the effective encoder among the N encoders. More specifically, for example, when an operation is performed for generating the recording restart signal (see FIGS. 5 and 6), or when an operation is performed for generating the recording stop signal (see FIGS. 7 to 9), the main control portion 18 may switch the encoder to be selected as the effective encoder from the “i”th encoder to the “j”th encoder. The “i”th and “j”th encoders are different encoders included in the N encoders (“i” and “j” are integers).

[Note 3]

The imaging device 1 may be used by being incorporated in any apparatus (e.g., a mobile terminal such as a mobile phone).

[Note 4]

It is possible to realize the imaging device 1 of FIG. 1 in hardware or in a combination of hardware and software. In a case where the imaging device 1 is built with software, a block diagram showing the blocks realized with software serves as a functional block diagram of those blocks. The functions may be prepared in the form of a computer program so that the functions are realized by having the computer program executed on a program execution apparatus (for example, a computer).

What is claimed is:

1. An imaging device, comprising:
an input moving image obtaining portion which obtains input moving image data which is image data of a moving image;
an image processing portion which includes a plurality of processing blocks which apply predetermined processing to the input moving image data to thereby generate output moving image data;
an operation portion which accepts a plurality of operations including a starting operation in which an instruction to start image recording is given; and
a control portion which selects any of the plurality of processing blocks as a target processing block and, after the starting operation is performed, records the output moving image data from the target processing block into a recording medium,
wherein
the control portion switches a processing block to be selected as the target processing block among the plurality of processing blocks according to an operation performed on the operation portion.

2. The imaging device of claim 1,
wherein
the plurality of operations further include: a stopping operation in which an instruction to stop image recording is given; and a specific operation that is different from the starting and stopping operations; and
the control portion switches the processing block to be selected as the target processing block among the plurality of processing blocks when the specific operation or the stopping operation is performed.

3. The imaging device of claim 2,
wherein
the plurality of processing blocks include first and second processing blocks which are different from each other; and,
in a case in which the specific operation is performed after the starting operation is performed, the control portion records output moving image data which has been outputted from the first processing block selected as the target processing block into the recording medium in a reference period which is from when the starting operation is performed until the specific operation is performed, while, after the reference period, the control portion switches the processing block to be selected as the target processing block from the first processing block to the second processing block and records output moving image data which has been outputted from the second processing block into the recording medium.

4. The imaging device of claim 3,
wherein, in the case in which the specific operation is performed after the starting operation is performed, the control portion deletes, from the recording medium, after the specific operation is performed, the output moving image data which has been outputted from the first processing block and recorded into the recording medium in the reference period.

5. The imaging device of claim 2,
wherein
the plurality of processing blocks include first and second processing blocks which are different from each other; and
in a case in which the stopping operation is performed after the starting operation is performed, the control portion records output moving image data which has been outputted from the first processing block selected as the target processing block into the recording medium in a reference period which is from when the starting operation is performed until the stopping operation is performed, while, after the reference period, the control portion switches the processing block to be selected as the target processing block from the first processing block to the second processing block and records output moving image data which has been outputted from the second processing block into the recording medium.

6. The imaging device of claim 5,
wherein,
in a case in which the specific operation has not been performed by timing when a predetermined time has elapsed after performance of the stopping operation, the control portion deletes, from the recording medium, after the timing, the output moving image data which has been outputted from the second processing block and stored into the recording medium after the reference period.
